(19) United States
(12) Patent Application Publication
(10) Pub. No.: US 2003/0179775 A1
(43) Pub. Date: Sep. 25, 2003

(54) Service delivery network system and method

(76) Inventors: Jason T. Carolan, Superior, CO (US); Mikael Lofstrand, Farnham (GB)

Correspondence Address: HOGAN & HARTSON LLP, ONE TABOR CENTER, SUITE 1500, 1200 SEVENTEEN ST., DENVER, CO, 80202, US

(21) Appl. No.: 10/103,494

(22) Filed: Mar. 20, 2002

(51) Int. Cl. H04J 3/16

(52) U.S. Cl. 370/469; 370/351

(57) ABSTRACT

A service delivery network is disclosed for delivering a plurality of services to users on a network. The service delivery network includes a service module having one or more service domains. Each service domain supports a service to be delivered to the users. The service module also includes a load balancing switch to access the service module and the service domains in response to a request or data packet for the service. The service delivery network can have additional service modules to support other services. The service delivery network also includes a distribution module to route communications within the service delivery network. The load balancing switch routes the packet according to a virtual internet protocol address that corresponds to the service domain.

### BACKGROUND OF THE INVENTION

1. Field of the Invention

The present invention relates to information networks, and, more particularly, the present invention relates to information exchange networks that electronically deliver information, data, and service to end-users.

2. Discussion of the Related Art

Today's networks move information and services. As advances are made in existing and future technologies, the demand for information will increase. Network design and solutions may have to account for a large number of users, transactions, and diverse content types. The designs and solutions may result in a different approach than that of standard infrastructures. Networks should support convergent services with high reliability and performance, while maintaining manageability and security. Typical networks may be designed based on a client-server architecture. Client-server architecture can lead to network design being completed before the services architecture is complete, and may decrease flexibility for services within the network to support multi-tiered services.

Many technology companies concentrate on services to the end user, rather than the technology itself. Service-based architectures may be applications that are accessed over internet protocol (“IP”) networks, such as domain name systems (“DNS”), Web, file transfer protocol (“FTP”), telnet, and the like. Web servers provide the front-end access points to the desired applications. For future architectures, the applications may need to be redesigned to map into a new architectural shift. Upgrading software and hardware without downtime may be difficult and may result in a re-design of the system architecture to introduce new services. Challenges may include satisfying growth and a need for continuous availability.

Several factors may impact future computing platforms and services delivered by service providers, such as bandwidth availability and growth, wireless services, disaster recovery and services, computer processing growth, and the like. These implications enhance the need for scalable, secure, and high performance network topologies. Service provider data centers, such as internet data centers, may be challenged to satisfy the growth of services and the desire for continuous availability. Thus, future network designs should account for network infrastructure to distribute data between the server instances.

### SUMMARY OF THE INVENTION

Accordingly, the present invention is directed to a service delivery network system and method.

A service delivery network for delivering a plurality of services is disclosed. The service delivery network includes a service module having a service domain. The service domain supports a service from the plurality of services. The service delivery network includes a load balancing switch to access the service module in response to a packet for the service.

A service module configured to deliver services over a network also is disclosed. The service module includes a plurality of service domains to host the services. The service domains comprise servers to store data and applications corresponding to the services. The service module also includes a plurality of host connection switches coupled to the plurality of service domains to facilitate interaction between the plurality of service domains. The service module also includes a load balancing switch coupled to the host connection switches to route information between the plurality of service domains.

A method for delivering a service to a user over a network also is disclosed. The method includes receiving a packet for the service at a service delivery network. The method also includes routing the packet to a service module within the service delivery network. The method also includes accessing a service domain within the service module to provide the service.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings:

FIG. 1 illustrates a network in accordance with an embodiment of the present invention.

FIG. 2 illustrates a service domain in accordance with an embodiment of the present invention.

FIG. 3 illustrates a service module within a service delivery network in accordance with an embodiment of the present invention.

FIG. 4 illustrates distribution and service modules within a service delivery network in accordance with another embodiment of the present invention.

FIG. 5A illustrates functional layers of a distribution module and functional layers of a service module in accordance with an embodiment of the present invention.

FIG. 5B illustrates routing through the functional layers of a service delivery network in accordance with an embodiment of the present invention.

FIG. 6A illustrates a network configuration within a service module in accordance with an embodiment of the present invention.

FIG. 6B illustrates a network configuration within a service delivery network in accordance with an embodiment of the present invention.

FIG. 7 illustrates a network configuration within a service delivery network in accordance with an embodiment of the present invention.

FIG. 8 illustrates an example of a service delivery network within a corporate intranet.

FIG. 9 illustrates an example of a service delivery network within an internet service provider.

FIG. 10 illustrates an example of service delivery networks within an internet service provider.

FIG. 11 illustrates a flowchart for providing a service over a network in accordance with an embodiment of the present invention.

### DETAILED DESCRIPTION OF THE DISCLOSED EMBODIMENTS

Reference will now be made in detail to the disclosed embodiments of the present invention, examples of which are illustrated in the accompanying drawings.

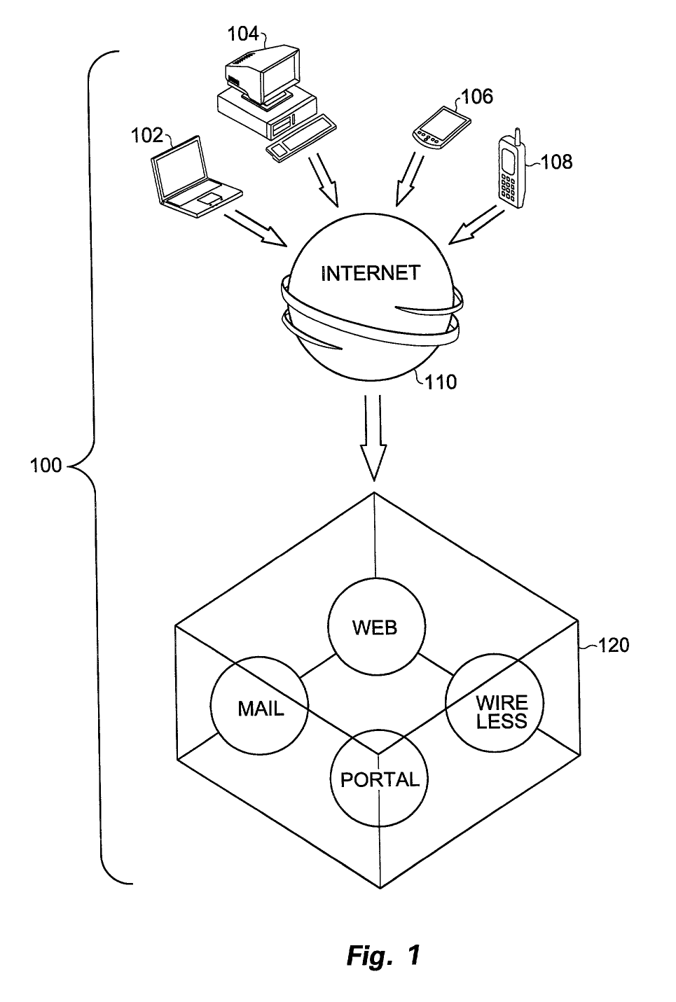

FIG. 1 depicts a network 100 in accordance with an embodiment of the present invention. Network 100 may be any network capable of transferring data and information from one component to another. Network 100 also may deliver requested services to end-users connected to network 100. For example, network 100 may include laptop 102, desktop 104, personal digital assistant (“PDA”) 106, and wireless telephone 108 that are linked to internet 110. These components may send and receive information from each other, or from other sources. Each component may receive information and data over internet 110 in a known manner.

Internet 110 may be coupled to data centers. Specifically, internet 110 may be coupled to service delivery network (“SDN”) 120. Internet 110 also may be coupled to other SDNs and data centers. Internet 110 may be coupled to a plurality of SDNs 120. SDN 120 is a data services platform for scalable data centers. The services provided over network 100, and supported by SDN 120, may include end-user, supporting, and infrastructure. Services are products or resources offered over a network to meet or to provide specific business requirements and may be categorized in different ways. According to the disclosed embodiments, services may indicate products or resources from an end user perspective.

End-user services may be provided directly to an end-user, and may include a Web site, email capability, Usenet services, and the like. Supporting services may support end-user services. Supporting services may include an application server providing dynamic content for a Web site or e-commerce application. The end-user service, however, is the service access point, and users should not directly initiate connections into a supporting service. Infrastructure services may ease internal operations and support, and may include system and network management services. An example of an infrastructure service may be an internal DNS service. Infrastructure services should not interact directly with end-user services.

SDN 120 may focus on the services delivered to the end-user, as opposed to technology, servers, or other components of network 100. Thus, SDN 120 may be known as a service-driven network. Alternatively, SDN 120 may focus on these issues in addition to delivered services. SDN 120 may be known as a client-service architecture in that the client connects to a service and not directly to a server. A user, or client, may not be interested in connecting to a specific server, but, instead, desires to connect to a requested service. SDN 120 can focus on the service for a highly scalable, module-based network topology that may grow as services grow, while keeping security and flexibility intact. Referring to FIG. 1, SDN 120 may provide mail, Web, portal, and wireless services to the components coupled to internet 110. These services may be supported by their own architectures, as disclosed in greater detail below.

SDN 120 may support unified service data centers. As services and providers continue to converge and provide different types of services, SDN 120 may provide increased speed, increased bandwidth-capable solutions with increased availability and flexibility. SDN 120 also promotes a client-service architecture that focuses on the services delivered to the customer, as opposed to servers. The customer, for example, may use laptop 102, desktop 104, PDA 106, or telephone 108, as disclosed above to access the services supported by SDN 120. SDN 120 may take advantage of a true service-driven architecture by virtualizing the servers and understanding the core services offered to the end user and data center services.

SDN 120 is a modular architecture that scales by adding computer processor units (“CPUs”) in servers, adding servers, adding modules, adding instances of an application, and the like. SDN 120 may be scaled in every aspect and may meet the demands for future growth. SDN 120 enables servers to be consolidated by using technologies in the architecture that receive increased utilization from every server.

Within SDN 120, integration points may be standardized in a secure and manageable manner. This feature may increase system and network management integration, and enables SDN 120 to maintain a consistent qualifying of service expectations for the service delivery. In addition, future data centers may demand architectures that keep the same structure, even if the hardware, software, or traffic pattern changes. An increase or decrease of services, servers, and applications may be supported. SDN 120 may support this flexibility with minimal or no service interruption.

SDN 120 may use a highly-scalable network topology that utilizes integrated load balancing and high-speed routing. SDN 120 also may include a services focus, intelligent service routing, integrated security, and modular design. These features allow SDN 120 to deliver services to an end-user in a more efficient and timely manner. Service delivery can be the priority of SDN 120 because end-users want their requested services in a timely manner. SDN 120 allows for emphasis on the services, and not the hardware. Concentrating on service delivery allows the customer to determine specific systematic or service qualities requirements for each service. The qualities may include availability, security, and performance.

SDN 120 also includes intelligent service routing, or service routing and load balancing, features that are available throughout the architecture. Services may be routed according to server availability or application information, such as session identification or content, or according to load characteristics, such as the least amount of connections. In addition, based on the implementation, bandwidth management capabilities may allow for higher quality of service levels for specific services.

SDN 120 also may feature integrated security. Security capabilities may be provided throughout the architecture, thereby protecting the servers, network hardware, and the data. Security may be provided at increased, or high, speeds and with low latency, while protecting the customer's valuable networked resources.

SDN 120 may be comprised of modules. Some of the modules may be needed, and others may be optional. Using modular design, SDN 120, and network 100, may be extended and expanded to meet changing service requirements. For example, SDN 120 may provide the foundation of network 100 for a multi-customer IDC that allows each customer to determine specific security or performance requirements.

SDN 120 may utilize service modules and distribution modules. SDN 120 may be built on service modules. Various layers within a service module provide the service address, ISR or distribution, and integration desired for SDN 120. These functions may be provided by the network hardware that is supported in SDN 120. Distribution modules may provide service expandability. After capacity has been reached within a single service module, a distribution module and additional service modules may be added to SDN 120. This feature allows for maximum flexibility and scalability of SDN 120. Service and distribution modules are disclosed in greater detail below. Thus, SDN 120 may comprise several modules and service domains. The modules and domains work together to provide the production service delivery platform and features that allow intelligent service routing within network 100.

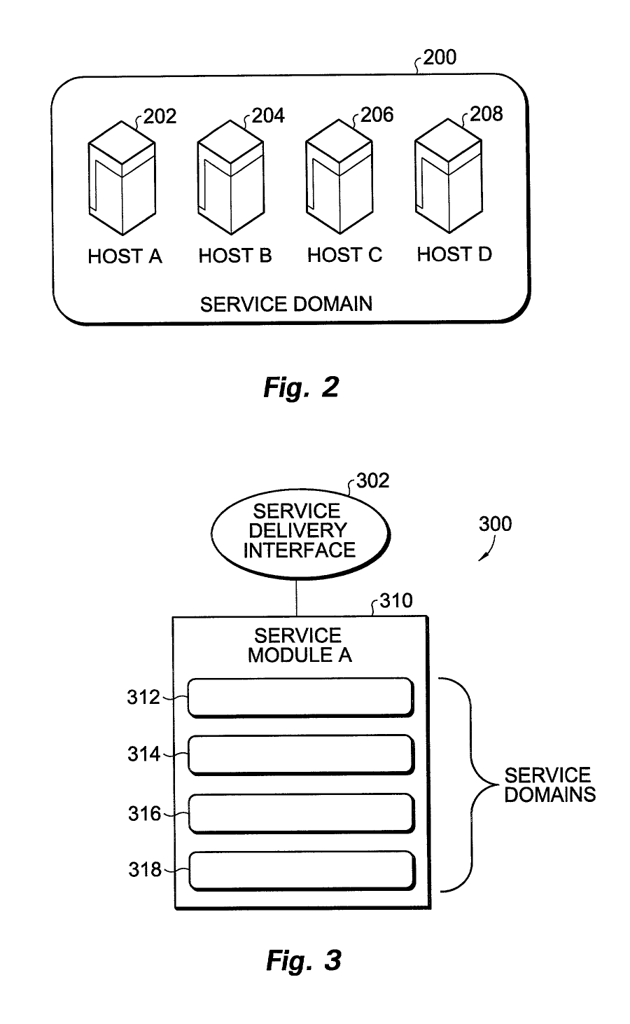

FIG. 2 depicts a service domain 200 in accordance with an embodiment of the present invention. Service domain 200 may be one of many service domains within a SDN, such as SDN 120. Service domain 200 is a logical grouping of related services and the hosts that provide these services. Service domain 200 comprises hosts including network appliances, and network access including gateways and access routers. For example, service domain 200 may comprise network appliances, such as servers 202, 204, 206, and 208. Services within an SDN, such as SDN 120, may be split into service domains, such as service domain 200. The services may be split according to several factors, such as logical groups, security requirements, ease of maintenance, load balancing, and the like. Members of service domain 200 should not require load balanced access to other members of service domain 200. By separating services into logical domains, an additional scalability mechanism is provided and enables services to take advantage of other service domains. For example, services may be comprised of service components. Service components, when placed together, provide the service. A service such as “email” may comprise three service components, such as receiving, composing, and sending emails

Logical groups may influence the services for service domain 200. For example, front-end email proxy services that include POP or IMAP may belong in the same service domain. Further, hosts, and their services, in service domain 200 should have the same security requirements to ease configuration requirements, as disclosed in greater detail below. In addition, an SDN, such as SDN 120, is simpler to design and maintain if the services are limited in service domain 200. For example, if service domain 200 offers HTTP, it may be easier to limit traffic to a single protocol. If services are desired internally, and should be load balanced, then the services should be in separate service domains. The traffic within the SDN can follow the intended load distribution.

Service domain 200 is a physical network segment, or broadcast domain. The servers 202-208 belonging to a particular service domain should belong to the same physical network. Service domain 200 may be outfitted with private, unrouted addresses. Because the address is not routed on the internet, the address also assists in securing the servers, or hosts, and network devices. Scalability also is provided as the addresses should not be used up by a network. With private addresses unrouted through the internet being used for each server, or host, connected to the network, a mechanism may be desired to provide publicly routed addresses when appropriate. Public services may be configured with internet protocol (“IP”) addresses and may be called virtual servers, service access points (“SAP”), or virtual IP (“VIP”) addresses. Public may apply to any routable network. The VIPs operate in conjunction with the load balancing system disclosed below and offer load distribution and network address translation.

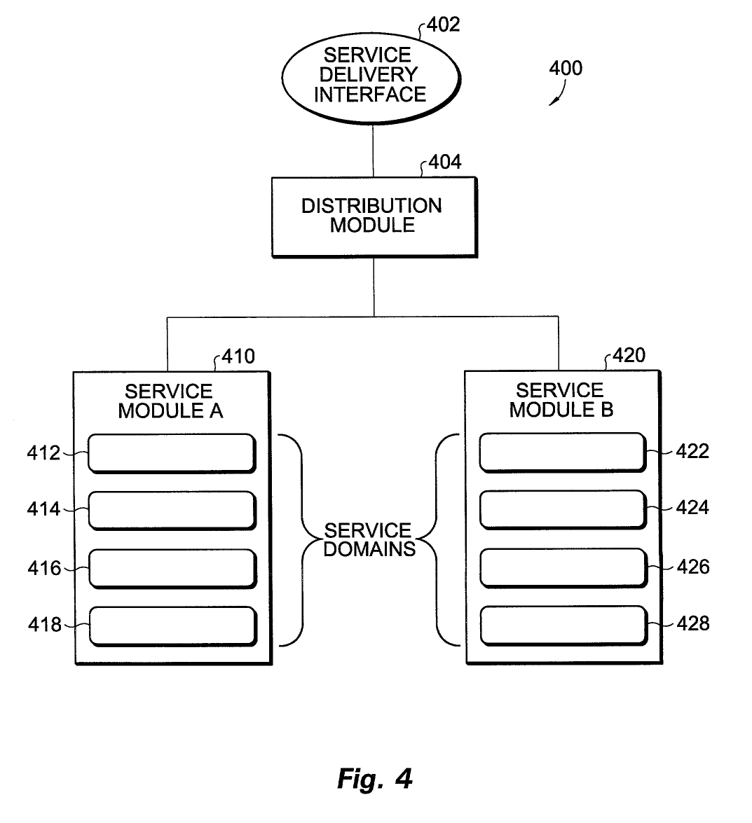

FIG. 3 depicts a service module 310 within a service delivery network 300 in accordance with an embodiment of the present invention. SDN 300 may correlate to SDN 120 of FIG. 1. Service module 310 is the basic building block within an SDN, such as SDN 120. Service module 310 may comprise physical network hardware, server connections for the production networks, and the software applications that comprise the services to be delivered. Service module 310 provides the services, the physical access, the routing, the distribution, the availability features, and the integration to other networks and network services. A service module may exist as a standalone component, or it may be linked together and scaled to provide virtually unlimited services.

Service module 310 also may comprise services that are separated into service domains 312, 314, 316, and 318. Service module 310 may support several service domains, and is not limited to the number depicted in FIG. 3. The following factors may determine, in addition to those disclosed with reference to service domain 200, how services are assigned, such as the services and their protocols, the requirement for services to communicate with other services, security requirements for the service, and the like. Thus, each service domain, such as service domain 312, provides a specific service, such as a wireless application protocol (“WAP”) gateway functionality. This feature allows each service to be scaled individually, which increases flexibility within SDN 300. As services are added to service module 310, new service domains are created and attached to the existing configuration. This feature increases network scalability. Further, the network hardware may perform some of the functions provided traditionally by firewalls.

Service delivery interface 302 is the primary service interface. Service delivery interface 302 may provide the integration point to upstream access providers or wide-area network (“WAN”) access. Service delivery interface 302 may not be considered a component of SDN 300. Alternatively, service delivery interface 302 may be part of SDN 300. The requirements for integration are based on the physical connections of the load balancing switch (“LBS”) and the basic requirements for network access, including IP routing. Availability and link redundancy may be provided by a variety of protocols. Virtual router redundancy protocol (“VRRP”) is preferred with static routing from the core router or switch to SDN 300. Other protocols, such as BGP, may be used as well. Convergence time, however, may be higher.

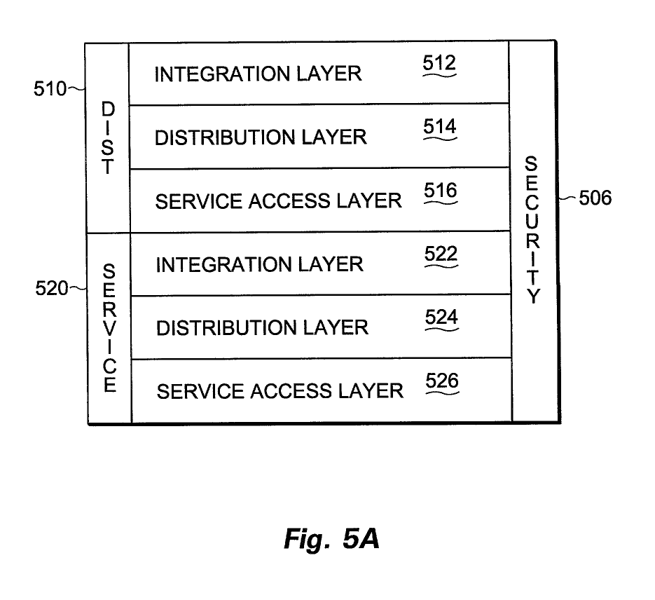

FIG. 4 depicts distribution and service modules within a service delivery network 400 in accordance with another embodiment of the present invention. SDN 400 correlates to SDN 300, but differs in configuration. The features disclosed with reference to FIG. 3 also may apply to SDN 400. SDN 400 couples to service delivery interface 402 that provides an integration point to upstream access providers. SDN 400 also includes service modules 410 and 420. Service module 410 may comprise service domains 412, 414, 416, and 418. Service module 420 may comprise service domains 422, 424, 426, and 428. As disclosed above, the service domains may provide different services on service modules 410 and 420.

SDN 400 also includes distribution module 404. Distribution module 404 comprises similar network components as service modules 410 and 420. Distribution module 404 enables several service modules to work together and aggregate services to service delivery interface 402. Distribution module 404 may be desired for large-scale implementations with different offered services and to integrate multiple service modules. Distribution module 404 also may support limited services, such as SDN-wide caching, global server load balancing for multi-site HA, DNS, and the like. Otherwise, all other services should be provided by service module 410 or 420.

Using distribution module 404, additional service modules may be attached to SDN 400. As demands for services increase, the growth may be accommodated by adding the services as service domains. Certain service domains, and their corresponding services, may want increased security or operate according to a different protocol from existing service modules 410 and 420. Thus, a new service module may be added to SDN 400. Interaction between service delivery interface 402 and existing service modules 410 and 420 may facilitated by distribution module 404.

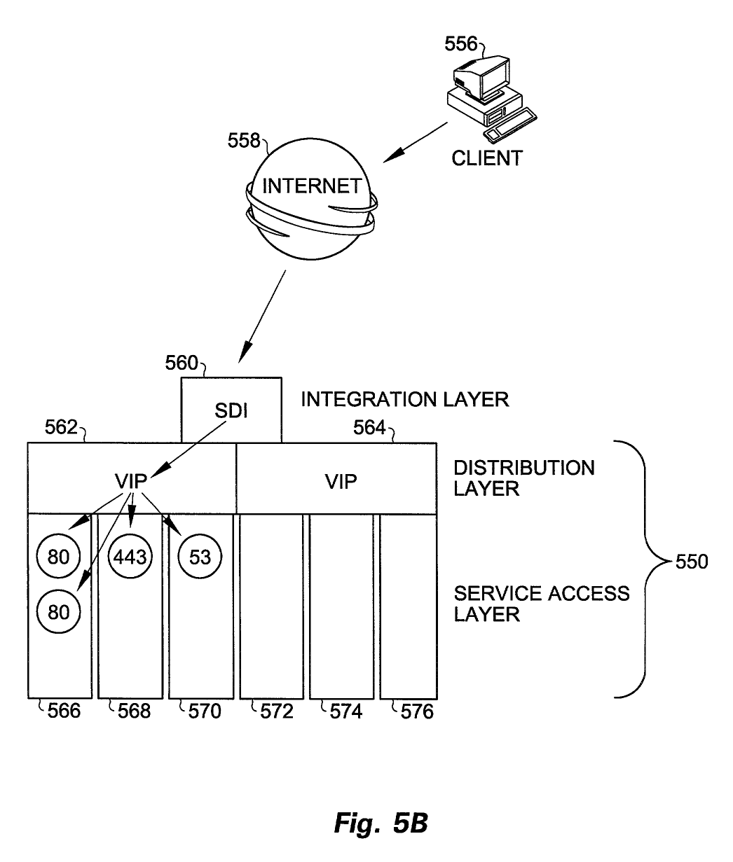

FIG. 5A depicts layers of a distribution module 510 and layers of a service module 520 in accordance with an embodiment of the present invention. Distribution module 510 may include integration layer 512, distribution layer 514, and service access layer 516. Service module 520 may include integration layer 522, distribution layer 524, and service access layer 526. Security layer 506 encompasses distribution module 510 and service module 520, and provides security for the different services within each module.

Integration layers 512 and 522 are provided by the service delivery interface, such service delivery interface 402. Integration layers 512 and 522 provide the physical connectivity and availability features to hosts, other network devices, and other networks. Integration layers 512 and 522 also host the services provided by the underlying infrastructure supporting distribution module 510 and service module 520.

Distribution layers 514 and 524 provide routing, distribution, public service presentation, and other features for distribution module 510 and service module 520, respectively. Service access layers 516 and 526 provide the interface between distribution layers 514 and 524, the service instances, and the physical components within the network architecture, including the various modules that comprise the SDN, such as SDN 400.

FIG. 5B depicts routing through the functional layers of a service module 550 in accordance with an embodiment of the present invention. The functional layers depicted in FIG. 5B correlate to the functional layers in FIG. 5A. A client 556 requests a service to be provided by service module 550. The request may be in the form of a data packet. Client 556 is linked to a large network, such as internet 558, to deliver the request to a service delivery network supporting service module 550. The request is routed by SDI 560, which interacts with the integration layer of service module 550.

Service module 550 includes service domains 566 and 576. Service domains may be identified for routing purposes by virtual IP 562 and 564. The distribution layer of service module 550 routes the received packets to the appropriate service domain according to the virtual IP 562 and 564. This process is disclosed in greater detail below. The virtual IP may not match the physical address of the corresponding service domain. The packet is routed according to the service requested or desired, and that service should be provided by the service domain that is identified by the integration layer of service module 550.

The service access layer of service module 550 may be represented by the services within service domains 566 and 576. For example, service domain 566 may include service 80. Service domain 568 may include service 443. The services may correspond to a host or server physically located with the service domain. The services further may be defined by ports corresponding to the servers within the service domains. For example, service domain 566 may have ports to route the data packet from client 556 after being processed by the distribution layer. According to FIG. 5B, two data packets may identify service 80 and is routed to port 80. Other data packets may identify services 443 and 53 and routed to ports 443 and 53, respectively.

Thus, client 556 may request a service by sending a data packet over internet 558. The data packet is routed to the appropriate service according to the virtual IP of the service domains within the service module of a service delivery network.

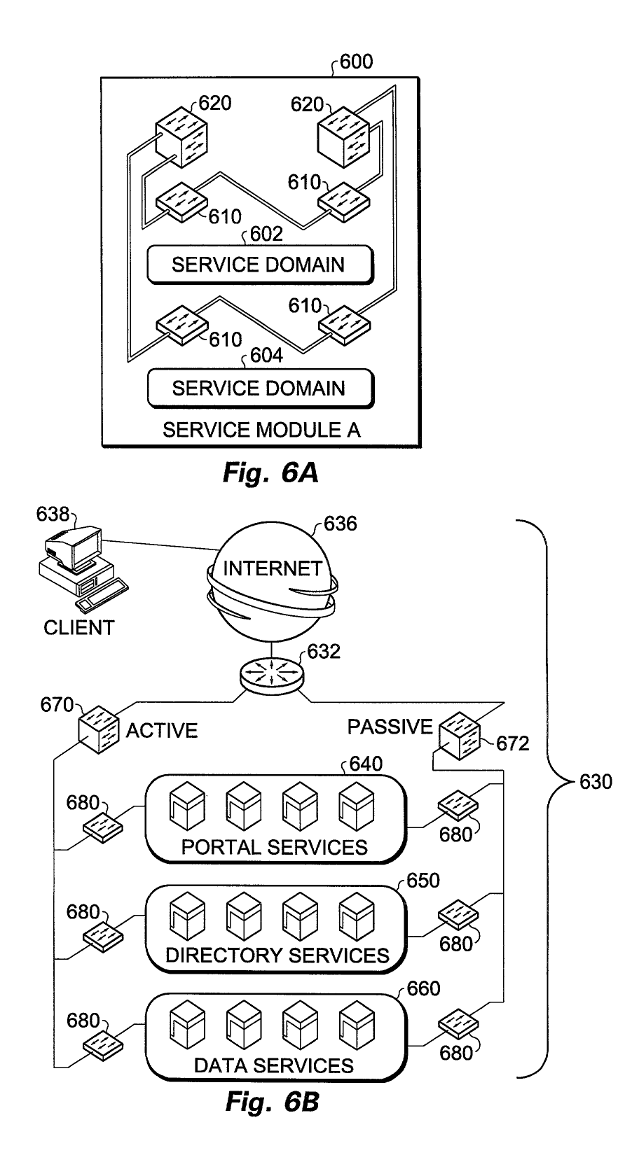

FIG. 6A depicts a network configuration within a service module 600 in accordance with an embodiment of the present invention. Each service module and distribution module of the disclosed embodiments may be comprised of common network equipment. The network equipment may include load-balancing switches (“LBSs”) and host connection switches (“HCSs”), as disclosed in greater detail below.

Service module 600 may comprise service domain 602 and service domain 604. Service module 600 also may comprise HCSs 610. HCSs 610 may provide simple functions to service module 600. HCSs 610 may attach hosts and servers within service domains 602 and 604 to an external or SDN network. Each host and server is expected to have at least two connections to meet customer requirements for high availability. Having two connections prevents the host connection to fail during a switch failure. A set of HCSs should be available for each service domain offered. HCSs 610 also may be used to link service modules together when utilizing a distribution module. HCSs 610 may be basic, high-speed, second generation, non-blocking, layer 2 switches. Alternatively, HCSs 610 may be any device or component that achieves the above-disclosed functionality within service module 600. HCSs 610 provide cost effective scalability of the features provided by LBSs 620, while also providing the features disclosed above. As service domains are added to service module 600, HCSs may be used to promote connectivity for the added service modules.

LBSs 620 may be key components within the network design. LBSs 620 offer most of the functional capabilities disclosed above. LBSs 620 should be scalable, feature-rich, high-speed, high-performance switches that are used within service module 600. LBSs 620 may provide routing between and to service domains 602 and 604. LBSs 620 may provide increased availability and distributed access to services within service module 600. LBSs 620 may be high-speed, high-performance switches used in an available design. Accordingly, LBSs 620 may replace layer 3 switches and routers in a traditional data center access network topology. LBSs 620 also may provide layer 3 through 7 switching, distribution, and load-balancing capabilities that may be desired for intelligent service routing. LBSs 620 and HCSs 610 can be switches that are provided by a network vendor. Each network vendor should have chassis-based and stackable-based configurations depending on the configuration design of the applicable SDN.

FIG. 6B depicts a network configuration within a service delivery network 630 in accordance with an embodiment of the present invention. SDN 630 may be coupled to a network via internet 636 to client, or end-user, 638. SDN 630 provides services to client 638, as defined by the service modules and service domains within SDN 630. In this instance, SDN 630 may provide portal services, directory service, and data services from service domains 640, 650, and 660, respectively. Access to SDN 630, and service domains 640, 650, and 660 from internet 636 may be through interface 632. Interface 632 may provide security and access functions to SDN 630, as disclosed above with reference, for example, to service delivery interface 402.

Service domains 640, 650, and 660 may be in a single service module, or may be in separate service modules. Further, service domains 640, 650, and 660 comprise servers to enable the functions disclosed above. For example, service domain 640 may include four servers that support portal services for SDN 630.

SDN 630 also includes HCSs 680 and LBSs 670 and 672. These switches may correspond to HCSs 610 and LBSs 620 disclosed above. HCSs 680 may connect service domains 640, 650, and 660 to SDN 630, or, alternatively, directly to the network supported by internet 636. HCSs 680 may link service domains 640, 650, and 660 to each other. LBS 670 may be an active load balancing switch and LBS 672 may be a passive load balancing switch within SDN 630.

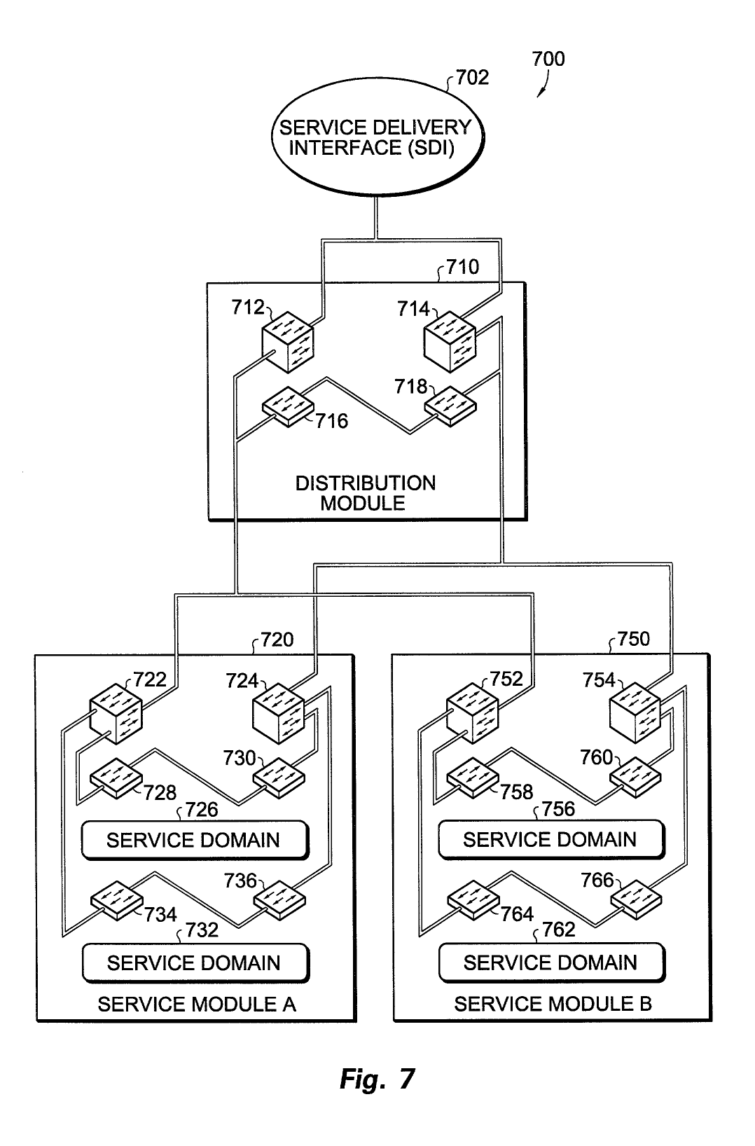

FIG. 7 depicts a network configuration within a service delivery network 700 in accordance with an embodiment of the present invention. SDN 700 includes SDI 702. Each distribution module and service module LBS within SDN 700 should have one upstream ingress/egress link. The link should have the capacity to support the requirements of the network and services. SDI 702 provides these links, as well as supports the integration layer of SDN 700. SDN 700 also includes distribution module 710 and service modules 720 and 750. Distribution module 710 includes active LBS 712 and passive LBS 714, as well as HCSs 716 and 718.

Service module 720 includes active LBS 722 and passive LBS 724. Service module 720 also includes service domains 726 and 732, that are coupled within service module 720 by HCSs 728 and 730, and HCSs 734 and 736, respectively. Service module 750 includes active LBS 752 and passive LBS 754. Service module 750 also includes service domains 756 and 762, that are coupled within service module 750 by HCSs 758 and 760, and HCSs 764 and 766, respectively.

Routing within SDN 700 may be performed by LBSs 712, 722 and 752. Routing is desired when a host, or server, attempts to communicate to another host or client off of its network segment, such as a service domain. After the router within an LBS identifies the location of a particular destination network or host, then the LBS may forward the packet appropriately. SDN 700 provides routing in service modules 720 and 750 by using the same hardware that performs the load balancing. Because each service is divided into service domains, the division provides for a highly scalable and high performing approach to service routing. The division of services also allows for additional controls to ensure certain types of packets are routed through SDN 700 into each service domain.

Inter-service domain routing in a service module may be accomplished as follows. Hosts in service domains, such as service domain 726, may be required to communicate to other hosts in service module 720, such as a supporting service. Two processes may provide inter-service domain communications. First, a service VIP may be provided through the LBSs. This approach enables the supporting service to be load balanced as well, such a set of DNS servers or LDAP servers. A set of service VIPs may be maintained like any other service in the LBSs, such LBSs 722 and 724. Alternatively, a static route may be provided to the particular host IP or set of IP addresses that is automatically maintained by the LBS, such as LBS 722. If load balancing is not desired, direct communication may be supported through static routes to each network in the LBS.

Routing outside the service module, such as service module 720, may be accomplished as follows. Routing to systems or networks outside the service module also may be provided by the LBSs, such LBS 722. LBS 722, for example, may be configured with static routes or may use routing protocols such as RIP, OSPF, or BGP. This route may include access to SDI 702 and the primary integration network, such as the internet. Many environments without BGP may use static route configurations because most internal addresses are private. This aspect allows for simple configuration of outside networks and a simple static configuration.

Service domains without service VIPs may be considered routing-only service domains. The LBS may be configured only to static route packets to these domains and may not translate or forward the packets to VIPs.

SDN 700 also supports the ability to load balance services through intelligent service routing (“ISR”). ISR is desirable for high availability of each service so that the services are able to withstand network or host outages. ISR also allows consistency of service by routing new customers to lower used hosts, or servers. ISR also allows the ability to route customers to the fastest service access point available across a geographic area or large WAN. ISR also allows security features that permit customers to connect only to service access points or service VIPs instead of the actual host.

LBSs 722 and 752 may provide several functions related to load balancing, such as translation, redirection, and health checks. Regarding translation, each LBS, such as LBS 722, publishes a service VIP for various services. The service VIP is publicly available and is routed over the network coupled to SDN 700. When a client connects to the service VIP, LBS 722 makes a decision based on the redirection and health check settings, and rewrites the packet, replacing the destination address and forwarding the packet to the desired host within its supporting service domain, such service domain 726. After the response has been made by the host, the packet is directed back to LBS 722 and the packet is rewritten again by replacing the address with the service VIP. The client should not be aware of this activity.

Redirection, or load balancing, indicates the ability for LBS 722, or other LBSs, to make various decisions based on settings and dynamic information obtained from health checks. Each LBS within SDN 700, such as LBS 722, is configured with a service VIP and with a load distribution algorithm, such as least connections or hashing. Unless session persistence or source-destination hashing is used, the client may receive a response from any host running the service. This feature may be desirable because the LBS may redirect the client to the server with the least connections. If the client is redirected to the same host every time, such as an application server holding session information, persistence should be used.

LBSs also may take into account several health factors of a host, network connection, or service. This ability varies, but it may be known to allow health checks by using pings, TCP connections, or application connections, such as HTTP. In a specified time frame, the LBS, such as LBS 722, checks to ensure availability and updates a table indicating that the host is alive and working. In addition, various vendors support customized APIs that enable customers to configure scripts and other automated settings. The requirements for this feature should be obtained from the customer, and support should be determined by the vendor documentation.

According to certain capacity values, an LBS, such as LBS 722, may be configured to send requests to a set of overflow hosts. During an extremely busy period, these hosts may forward requests to a static Web page that details the extreme load. This alternative may be preferable to allowing the client to time-out. LBSs also may provide bandwidth management features.

Scalability of services infrastructure maintains adequate service levels with a constantly growing and expanding customer base. The ability to add new services or to enhance existing services should be supported by the network architecture and not require significant changes. The scaling model for adding services according to the disclosed embodiments should be similar to server scaling. Server scaling may be discussed in terms of horizontal and vertical scaling. Adding servers offering the same service may be an example of horizontal scaling. Vertical scaling may involve adding CPUs or other hardware components within the same server. Some applications may not take advantage of additional server hardware and should be horizontally scaled. In some instances, the vertically scaled server may be out of capacity and is scaled by adding more hosts. This technique may be applied to SDN 700.

Services may be added within service domains 726, 732, 756, or 762 if the services logically meet the service domain requirements disclosed above. Additional service domains may be added to service modules 720 or 750 by adding HCSs. If additional capacity is desired by a service, the service may be split into different service domains, although the service delivery integration is shared by the entire service module. Adding service domains may be limited by specific hardware density and limitations.

If additional service domains are desired within, for example, service module 720, a service module may be added and integrated using distribution module 710. With two service modules, such service modules 720 and 750, the bandwidth support by SDI 702 may increase, even though each service module is still serviced through the bandwidth of the original connection. To use the increase bandwidth capacity of SDI 702, services should be distributed between service modules 720 and 750.

Distribution module 710 enables multiple service modules 720 and 750 to be connected and integrated to form SDN 700. Distribution module 710 may be desirable for additional services or service domain are needed because the number of services in a service module has reached its maximum capacity. Distribution module 710 also is desired for additional bandwidth for SDI 702. Further, distribution module 710 may be desirable when content delivery network requirements use large capacity caches that should be integrated as close to SDI 702 as possible. Additional availability may be needed and addressed by distributing service modules to another location. Distribution module 710 may act as a distribution layer to transfer data and services to a separate site by using long-wave optical connections. Thus, distribution module 710 introduces an amount of flexibility by allowing customer needs, requirements, and services to change while still using the same basic service modules.

Distribution module 710 may be comprised of two LBSs 712 and 714 that provide load balancing and routing, and two HCSs 716 and 718 that provide scalable connections and allow for limited host connections, such as large high-speed content cache servers. By using HCSs 716 and 718, the ports on LBSs 712 and 714 may be used for connections to SDI 702, as opposed to limiting the number of service modules that may be supported. The HCSs within distribution module 710 may be expanded to include more service modules.

Distribution module 710 provides various capabilities for SDN 700. Some of these functions may be moved from the distribution layer and integration layer in a service module to the distribution module. Distribution module 710 provides high performance, wire-speed bridging and routing with low latency. Distribution module 710 also provides a scalable design with service module connection options. Distribution module 710 also provides network address translation capabilities without additional hardware. Distribution module 710 also provides a highly available infrastructure without a single point of failure and several methods to ensure service module network availability. Distribution module 710 also provides bandwidth management with guaranteed throughput to various services and/or clients with various quality of service capabilities. Distribution module 710 also provides content-based load balancing with delayed session binding support, a variety of health checks, and various load balancing algorithms and persistence options. Distribution module 710 also provides single service virtual IPs that are available to customers and distributed intelligently based on load and geographical data. Distribution module 710 also provides a managed network giving support for common network management platforms, with secure administration.

Distribution module also provides connectivity and routing access to service modules 720 and 750 and to SDI 702, or integration network. Routing within a service module may still be handled by the LBSs within the local service module. SDI 702, however, provides access to the primary integration network, such as the internet. The integration network may be responsible for routing to and from SDI 702 and LBSs 712 and 714. After a packet reaches LBSs 712 and 714, LBSs 712 and 714 are responsible for routing the packet in SDN 700. This routing may be accomplished by static route table entries in LBS 712 or 714. Traffic from service modules 720 and 750 with a destination inclusive of the integration network, or its connections, also may be routed by using static routes.

Data routing between service modules 720 and 750 also may be provided by distribution module 710. The routing may be configured using static route entries because they do not require dynamic updates and are constantly available. Additional routes should not be needed to support additional hosts but may be desired to support additional service domains.

The load balancing functions at distribution module 710 should be identical to those within service modules 720 and 750. Because of the hierarchical arrangement, some functions may be distributed to the distribution module layer that offloads some of the traffic at each service module. The arrangement also allows for additional content load balancing to occur above service module 720 and 750 and redirection to edge services, such as cache servers. The cache servers may cache content located anywhere within any service module or even the integrated network. The arrangement may serve to limit the amount of traffic routing through each service module.

Distribution module 710 also may provide a monitoring function for service modules 720 and 750 of SDN 700. A very high availability environment may include the same service being in separate service modules. Distribution module 710 may perform health checks on each service. This feature may allow a site to take down one service domain having the service for maintenance, and keep the other service domain running.

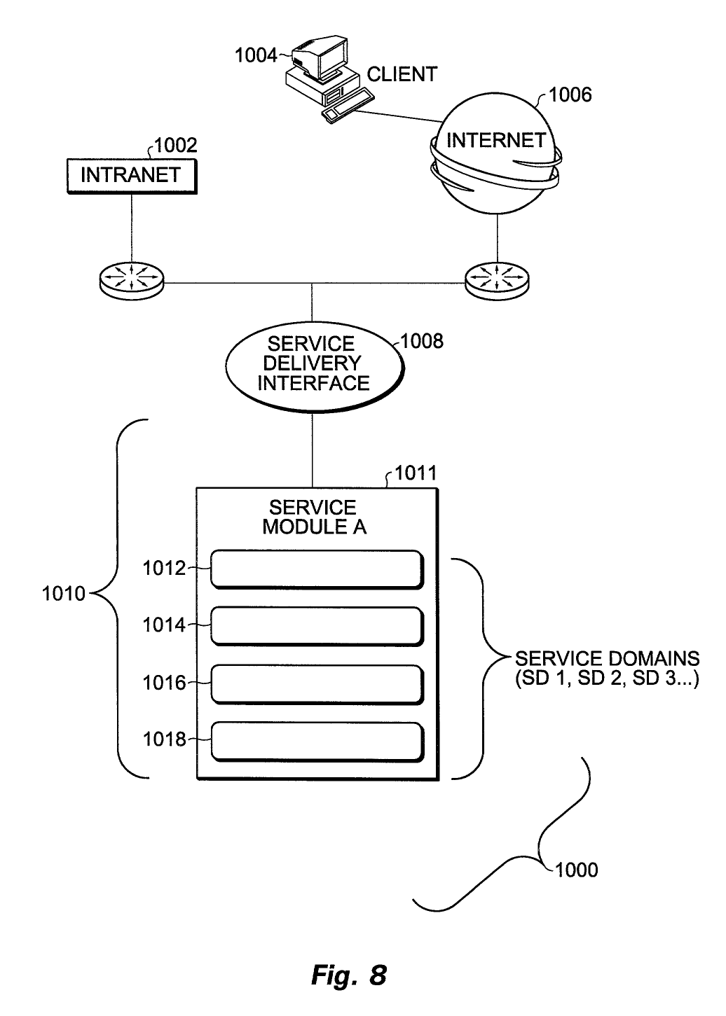

FIGS. 8-10 depict implementation examples of a service delivery network. These examples illustrate the flexibility and scalability of the disclosed embodiments. The present invention, however, is not limited to these examples, or the subject matter disclosed with reference to the examples. For example, implementation of a service delivery network also may include management or backup networks.

FIG. 8 depicts an example of a service delivery network 1010 within a corporate intranet 1002. In this example, a corporate information technology department has chosen to use SDN 1010 to deploy several internal services. Network 1000 also includes external networking to client 1004 via internet 1006. Thus, intranet 1002 should integrate some external systems, such as email, in addition to internal systems. Service delivery interface 1008 includes access to internet 1006 for emails and the corporate wide area network.

SDN 1010 may include service module 1011 that provides services as needed to intranet 1002. Service module 1011 may comprise service domains 1012, 1014, 1016, and 1018 that support different services. For example, service domain 1012 may support Web services that provide internal Web pages. Service domain 1014 may support human resources application services from a human resources database. Service domain 1016 may support human resources database services, and corresponds to service domain 1014. Service domain 1018 may support front-end email services for intranet 1002. Additional service domains may support email multiplexor services and message store services. Service domains may be added to service module 1011 as additional services are desired over intranet 1002 or network 1000.

Thus, for example, if Web services are desired by a user on intranet 1002, then service domain 1012 is accessed. The access request is received at SDN 1011 after service delivery interface 1008 serves as an integration point for the service requests. Servers within service domain 1012 are engaged to provide the service and to execute any applications to support the Web services. Thus, servers in the other service domains are not engaged. Further, if Web services is desired to be removed from intranet 1002 or network 1000, then service domain 1012 may be removed from service module 1011 without severely impacting the other services provided by SDN 1011.

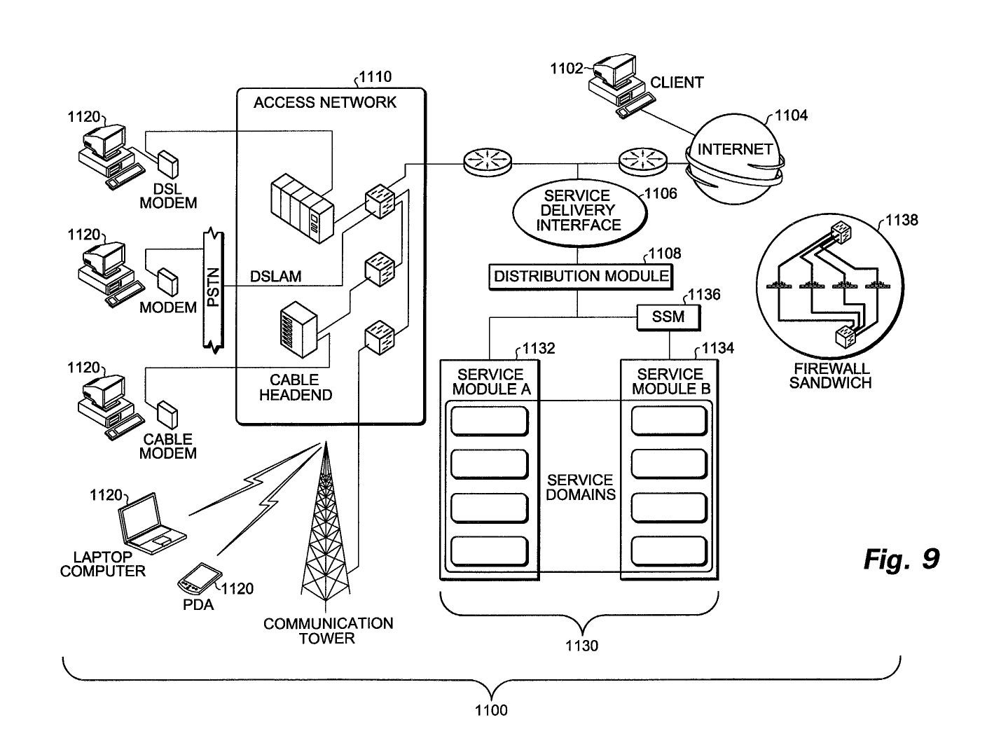

FIG. 9 depicts an example of a service delivery network within an internet service provider (“ISP”) 1100. ISP 1100 may be a medium-size ISP implementing core ISP services. ISP 1100 allows users 1120 to post Web pages to an external Web hosting service and also provides network access for dial-up, broadband, and wireless users 1120. Users 1120 may use desktops, laptops, PDAs, and the like to couple with access network 1110 to receive information and services over internet 1104. Users 1120 also may use modems, digital subscriber line modems, cable modems, communication towers, and the like to link to access network 1110.

As service requests are generated by users 1120, service delivery interface 1106 receives those requests intended for SDN 1130 and integrates the requests. Distribution module 1108 is coupled to the service modules within SDN 1130 and enables the service modules to communicate and work together. Distribution module 1108 also aggregates services to service delivery interface 1106.

SDN 1130 may include service modules 1132 and 1134. Service modules 1132 and 1134 may provide distinct services to ISP 1100. Service modules 1132 and 1134 are comprised of service domains that support the provided services with host servers. The service domains may correlate to other service domains supported on a different service module. For example, service module 1132 may support service domains that provide access services, email services, and directory services. Each one of these services may be broken into sub-services, such as front-end email services and message store services for email services. A service domain may support each sub-service such that service module 1132 has several service domains. Service module 1134 also may support services over several service domains, such as corporate Web services, database services, and domain name services. These services also may be broken into sub-services on different service domains. The service domains, as disclosed above, may communicate to each other and to other service modules via switches within the service modules and SDN 1130.

Network 1100 also may be a multi-customer hosting provider that provides network access for many different customers. SDN 1130 may have flexibility in meeting security requirements and the ability to scale each customer individually. A service module may be provided for each customer such that the service module may configured to the customer's requirements. For example, one customer may desire a service module with heightened security. Thus, service security module 1136 is provided for service module 1134, while service module 1132 may use the integrated security provided by SDN 1130. Service security module 1136 may comprise firewall sandwich 1138. The customer accessing service module 1134 may have sensitive data or applications on the servers within the service domains of service module 1134.

Thus, a user within users 1120 may request a service provided by network 1100. The service may be supported by a service domain on service module 1132 of SDN 1130. The service domain is accessed after the request has been integrated by service delivery interface 1106 and routed to service module 1132 by distribution module 1108. The servers within the service domain execute the applications and to deliver the service to the user. For example, if the user desires web services, a service domain supporting Web services is engaged to deliver the Web services over network 1100. If the user desires secure information, such as billing information, distribution module 1108 may route the service request to service module 1134, with security measures enabled by service security module 1136.

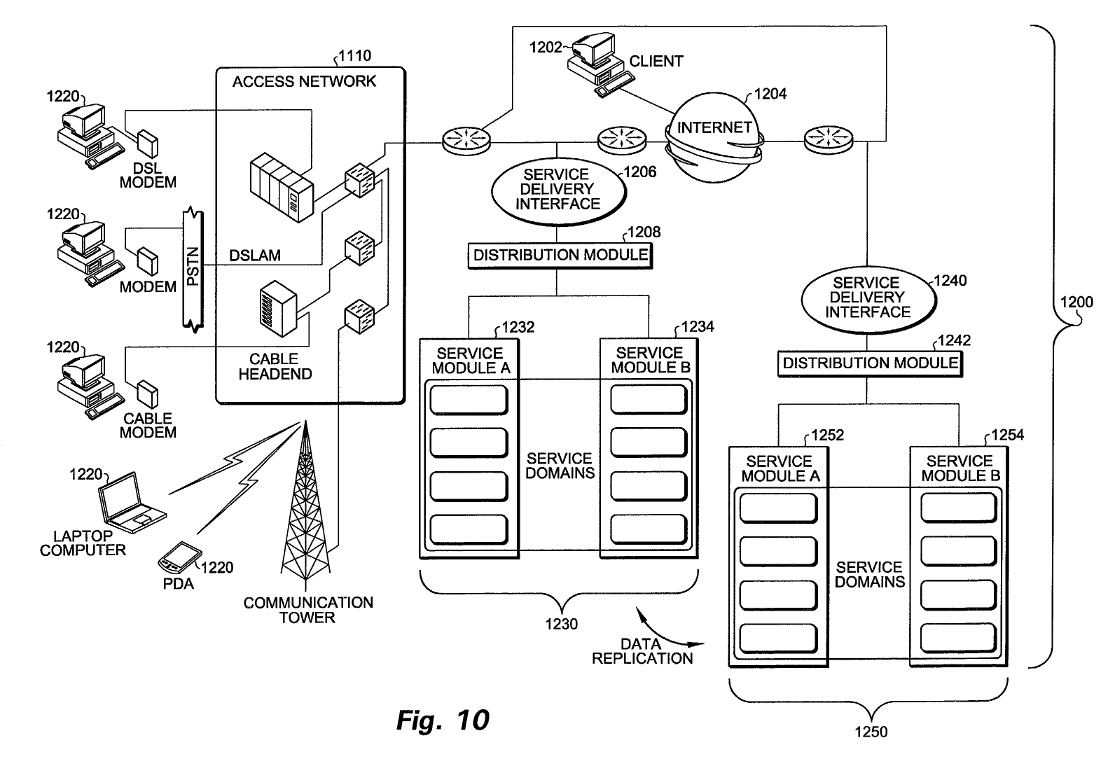

FIG. 10 depicts an example of service delivery networks 1230 and 1250 within an internet service provider (“ISP”) 1200. This example expands on the example disclosed above. ISP 1200 includes a multi-site ISP that has customer data at two locations, SDN 1230 and SDN 1250. Dynamic global server load balancing may be used at each site to ensure proper client redirection. Customer data may be replicated at SDNs 1230 and 1250 using a back-end integration network.

Users 1220 may use desktops, laptops, PDAs, and the like to couple with access network 1210 to receive information and services over internet 1204. Users 1220 also may use modems, digital subscriber line modems, cable modems, communication towers, and the like to link to access network 1210.

As service requests are generated by users 1220, service delivery interface 1206 receives those requests intended for SDN 1230 and integrates the requests. Distribution module 1208 is coupled to the service modules within SDN 1230 and enables the service modules to communicate and work together. Distribution module 1208 also aggregates services to service delivery interface 1206.

SDN 1230 may include service modules 1232 and 1234. Service modules 1232 and 1234 may provide distinct services to ISP 1200. Service modules 1232 and 1234 are comprised of service domains that support the provided services with servers. The service domains may correlate to other service domains supported on a different service module. For example, service module 1232 may support service domains that provide access services, email services, and directory services. Each one of these services may be broken into sub-services, such as front-end email services and message store services for email services. A service domain may support each sub-service such that service module 1232 has several service domains. Service module 1234 also may support services over several service domains, such as corporate Web services, database services, and domain name services. These services also may be broken into sub-services on different service domains. The service domains, as disclosed above, may communicate to each other and to other service modules via switches with the service modules and SDN 1230.

Further, ISP 1200 includes SDN 1250. SDN 1250 includes service modules 1252 and 1254. Moreover, service delivery interface 1240 and distribution module 1242 correlate to service delivery interface 1206 and distribution module 1208 in that service requests are received, integrated and distributed to the proper service domains in service module 1252 or 1254. SDN 1250 may replicate the service domains within SDN 1230. Thus, customers, or users 1220, may access either SDN 1230 or SDN 1250 to receive the desired service. Alternatively, both SDN 1230 and SDN 1250 may be accessed to deliver the services requested. Thus, if a customer requests billing and accounting services and information, then a service domain within SDN 1230 may be engaged or a service domain within SDN 1250 may be engaged. Decisions on which SDN to access to deliver the service may be based upon availability, location of the SDN to the customer, security measures, paths of least latency, and the like. Further, the accessed SDN may be assigned randomly to deliver the requested service.

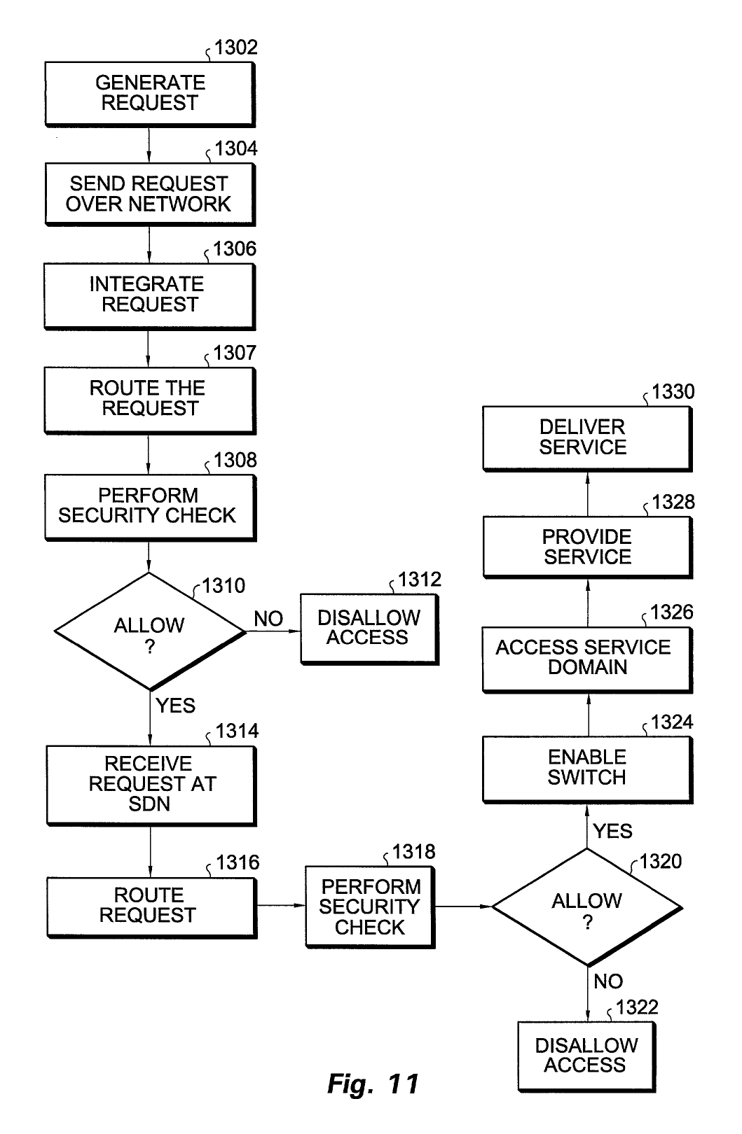

FIG. 11 depicts a flowchart for providing a service over a network in accordance with an embodiment of the present invention. The network may be capable of providing, supporting and delivering a multitude of services to a variety of user on different platforms. Step 1302 executes by generating a request for a service. The request may be generated from a user linked to the network. The user may be linked by a communication medium, such as the internet. Step 1304 executes by sending the request over the network to the applicable service provider. The user may be linked to the network by an access network.

Step 1306 executes by integrating the request at a service delivery interface coupled to a service delivery network. The service delivery network should be able to provide and support the service requested by the user. Step 1307 executes by routing the request to a service module. A distribution module may route the request, if present. Step 1308 executes by performing a security check on the request and its corresponding information before delivering the request to the service delivery network. An integration security module may be used to provide the security check. Step 1310 executes by determining whether the request should be allowed to the service delivery network. If no, then step 1312 executes by disallowing the request. An appropriate message may be sent noting that access to the service has been disallowed. If step 1310 is yes, then step 1314 executes by receiving the request at the service delivery network.

Step 1316 executes by routing the request to the appropriate service module. The request may be routed by a distribution module within the service delivery network, especially if there is more than one service module. Otherwise, the request may be routed by the service delivery interface. Step 1318 executes by performing a security check within the service delivery network. The security check may be performed by a service security module. Step 1320 executes by determining whether to allow the service to be accessed within the service module. If no, then step 1322 executes by disallowing access to the service module. This step may not mean that access is denied to other service modules within the service delivery network.

If step 1320 is yes, then step 1324 executes by enabling a switch within the service module to route the request to the appropriate service domain. The switch facilitates communication between the service module, service domain, and the network. Step 1326 executes by accessing the service domain that supports and provides the service requested by the user. Service domain may include servers that host the data and applications to provide the requested service. The applications may be executed and the data used to support the service over the network. Step 1328 executes by providing the service through connections to the network and running the servers within the service domain. Step 1330 executes by delivering the service over the network via the communication medium to the user. Additional requests and information exchange may occur as disclosed above. In an alternative embodiment, no security checks may be performed on the information exchanged from the network and the service delivery network or service module.

Thus, the disclosed embodiments provide advantages and improvements over known network systems. The nature of the internet economy is dynamic. Thus, network infrastructure should change in terms of size and functionality. By incorporating a modularized architecture as disclosed above, new functions may be integrated by conceptualizing the functions as modules and mapping from conceptual modules to physical modules that comprise hardware and software components at varying levels of abstraction. The disclosed embodiments allow the system architecture to be loosely coupled so that addition and removal of services and components may occur without major integration efforts. Further, the structure may be changed as applications change.

It will be apparent to those skilled in the art that various modifications and variations can be made in the present invention without departing from the spirit or scope of the invention. Thus, it is intended that the present invention covers the modifications and variations of this invention that come within the scope of any claims and their equivalents.

What is claimed:

1. A service delivery network for delivering a plurality of services, comprising:
a service module having a service domain, wherein said service domain supports a service from said plurality of services; and
a load balancing switch to provide a virtual internet protocol address for said service module, such that a packet is routed to said service domain using said virtual internet protocol address.

2. The service delivery network of claim 1, wherein said service module includes another service domain that supports another service.

3. The service delivery network of claim 1, wherein said service domain comprises at least one network attached device to support said service.

4. The service delivery network of claim 1, further comprising a distribution module coupled to said service module, wherein said distribution module routes said packet to said load balancing switch.

5. The service delivery network of claim 4, wherein said distribution module includes another load balancing switch.

6. The service delivery network of claim 1, wherein said service domain is coupled to said load balancing switch by a physical host connection switch.

7. The service delivery network of claim 1, wherein said service domain is coupled to said load balancing switch by a host connection switch comprised of virtual switches.

8. The service delivery network of claim 1, wherein said service domain has a physical address.

9. The service delivery network of claim 8, wherein physical address corresponds to said virtual internet protocol address.

10. The service delivery network of claim 1, further comprising another service module within said service delivery network, said another service module having another service domain.

11. The service delivery network of claim 1, wherein said service module comprises an integration layer, a distribution layer, and a service access layer.

12. A network for delivering a service to a user, comprising:
a service delivery network to host a plurality of services including said service, wherein said service delivery network includes a service module to support said service;
a service delivery interface to integrate a packet to be routed to said service module; and
a communications medium coupling said user and said service delivery interface, wherein said service is provided across said communications medium according to said packet.

13. The network of claim 12, wherein said service module comprises a service domain to support said service.

14. The network of claim 13, wherein said service domain comprises network appliances.

15. The network of claim 12, wherein said communications medium is the internet.

16. The network of claim 12, wherein said service delivery network includes a distribution module to route said request to said service module.

17. The network of claim 12, wherein said packet is routed to said service module according to a virtual internet protocol address.

18. The network of claim 12, wherein said service delivery network includes another service module.

19. The network of claim 12, further comprising another service delivery network, wherein said another service delivery network supports said service.

20. The network of claim 12, further comprising an access network to couple said users to said communication medium.

21. A service module configured to deliver services over a network, comprising:
a plurality of service domains to host said services, wherein said service domains comprise servers to store data and applications corresponding to said services;
a plurality of host connection switches coupled to said plurality of service domains to facilitate interaction between said service domains; and
a load balancing switch coupled to said host connection switches to route information between said plurality of service domains.

22. The service module of claim 21, wherein said load balancing switch includes a static table for receiving and routing a request for said services to said service domains.

23. The service module of claim 22, wherein said load balancing switch includes dynamic conditions for receiving and routing a request for said services to said service domains.

24. A method for delivering a service to a user over a network, comprising:
receiving a packet for said service at a service delivery network;
routing said packet to a service module within said service delivery network according to a virtual internet protocol address; and
accessing a service domain within said service module to deliver said packet.

25. The method of claim 24, further comprising integrating said request at a service delivery interface coupled to said service delivery network.

26. The method of claim 24, wherein said routing is performed by a distribution module within said service delivery network.

27. The method of claim 24, further comprising enabling a load balancing switch coupled to said service domain to route said packet.

28. The method of claim 27, further comprising translating said virtual internet protocol address to a physical address for said service domain.

29. The method of claim 28, wherein said translating includes rewriting said packet with a destination address.

30. A system for delivering a service to a user over a network, comprising:
means for receiving a packet for said service at a service delivery network;
means for routing said packet to a service module within said service delivery network according to a virtual internet protocol address; and
means for accessing a service domain within said service module to deliver said packet.

31. A method for providing a service over a network, comprising:
receiving a packet for said service at a service delivery network coupled to said network;
integrating said packet at a service delivery interface coupled to said service delivery network;
routing said packet to a service module that supports said service within said service delivery network;
enabling said service from a service domain within said service module; and
delivering said service over said network from said service domain.

32. The method of claim 31, further comprising allowing said packet access to said service delivery network.

33. The method of claim 31, further comprising allowing said packet access to said service module.

34. A system for providing a service over a network, comprising:
means for receiving a packet for said service at a service delivery network coupled to said network;
means for integrating said packet at a service delivery interface coupled to said service delivery network;
means for routing said packet to a service module that supports said service within said service delivery network;
means for enabling said service from a service domain within said service module; and
means for delivering said service over said network from said service domain.

35. A computer program product comprising a computer useable medium having computer readable code embodied therein for delivering a service to a user over a network, the computer program product adapted when run on a computer to execute steps, including:
receiving a packet for said service at a service delivery network;
routing said packet to a service module within said service delivery network according to a virtual internet protocol address; and
accessing a service domain within said service module to deliver said packet.

36. A computer program product comprising a computer useable medium having computer readable code embodied therein for providing a service over a network, the computer program product adapted when run on a computer to execute steps, including:
receiving a packet for said service at a service delivery network coupled to said network;
integrating said packet at a service delivery interface coupled to said service delivery network;
routing said packet to a service module that supports said service within said service delivery network;
enabling said service from a service domain within said service module; and
delivering said service over said network from said service domain.
